(19) United States
(12) Patent Application Publication
(10) Pub. No.: US 2006/0060150 A1
(43) Pub. Date: Mar. 23, 2006

(54) Fish guard for aquarium filtration systems

(76) Inventor: Brady Green, Jacksonville, FL (US)

Correspondence Address: Mark J. Young;Suite 227, 9951 Atlantic Blvd., Jacksonville, FL, 32225, US

(21) Appl. No.: 10/943,592

(22) Filed: Sep. 17, 2004

(51) Int. Cl. A01K 63/00

(52) U.S. Cl. 119/245

(57) ABSTRACT

A fish guard includes a panel, a plurality of columns of apertures, and a hooked shape top section operatively attached to the panel and configured to detachably engage a top edge of a wall of an aquarium receptacle. Each column of apertures includes a plurality of apertures disposed in substantial horizontal alignment. Each of the plurality of columns of apertures is also substantially in vertical alignment and horizontal alignment with a vertically disposed slot of the receptacle when the fish guard is installed. A kit includes a front fish guard and two side fish guards.

### FIELD OF THE INVENTION

This invention generally relates to aquarium filtration, and more particularly, to a detachable guard configured to prevent small fish from being drawn into a filtration receptacle.

### BACKGROUND

A filtration system commonly used in aquariums includes a receptacle (referred to herein as a pre-filter or pre-filter receptacle, but also known in the art as a skimmer or overflow receptacle) mounted inside the aquarium at the top. A siphon tube is provided for carrying water from the pre-filter to an external filter receptacle mounted directly behind the pre-filter receptacle on the outside of the aquarium. The filter receptacle may include mechanical, chemical and/or biological filters. Water passes through an outlet in the bottom of the filter receptacle and travels through conduit to a pump. The pump returns the filtered water to the aquarium tank.

Conventional pre-filter receptacles include a generally rectangular shaped bottom wall, a back wall, front wall and end walls. The top edge portion of each of the side walls and front wall typically has a plurality of vertically disposed slots. The width of each slot is sufficiently large to permit unobstructed passage of foreign matter carried by water from the interior of the aquarium tank to the interior of the pre-filter receptacle. While the slots are small enough to typically prevent the passage of large fish, small fish often pass through the pre-filter slots and are drawn into the filter receptacle where they eventually die.

A device for preventing small fish from being drawn into a pre-filter receptacle is needed. Preferably, the device is detachable so that it may be cleaned periodically. The device should also not interfere with conventional aquarium configurations. Additionally, the device should not impede the flow of waste through the slots or create waste. For example, backsplash and eddy currents may prevent adequate filtration of affected areas of the aquarium.

The invention is directed to overcoming one or more of the problems as set forth above.

### SUMMARY OF THE INVENTION

To solve one or more of the problems set forth above, in an exemplary implementation of the invention, a fish guard for an aquarium receptacle is provided. The aquarium receptacle (e.g., a pre-filter receptacle) has a plurality of vertically disposed slots, a front wall, a left side wall and a right side wall. Each of the walls has a top edge. An exemplary fish guard includes a panel; a plurality of columns of apertures, each column of apertures including a plurality of apertures disposed in substantial horizontal alignment; and a hooked shape top section operatively attached to the panel and configured to engage a top edge of a wall of the aquarium receptacle. Each of the plurality of the columns of apertures is substantially in vertical alignment and horizontal alignment with one of the plurality of vertically disposed slots when the fish guard is installed on the aquarium receptacle.

The fish guard is preferably configured to detachably attach to a wall of the aquarium receptacle. In one embodiment, the plurality of apertures are comprised of approximately 0.10 to 0.25 inch diameter circular holes; each aperture in a column of apertures is separated vertically from an adjacent aperture, measured aperture center to adjacent aperture center, by approximately 0.15 to 0.35 inches; each column of apertures is separated horizontally from an adjacent column of apertures by approximately 0.50 to 1.0 inches; and the panel is approximately 1 to 2 inches in height and approximately 2.5 to 5 inches in length for a front fish guard, or approximately 1.5 to 3.5 inches in length for a side fish guard.

The top edge of the wall of the aquarium receptacle has a thickness, which may vary from receptacle to receptacle. In one preferred embodiment the hooked shape top section of the fish guard defines an opening approximately equal to the wall thickness.

A fish guard kit for an aquarium receptacle is also provided. The kit includes a front fish guard and two side fish guards.

### BRIEF DESCRIPTION OF THE DRAWINGS

The foregoing and other objects, aspects and advantages will be better understood from the following detailed description of an embodiment of the invention with reference to the drawings, in which:

FIG. 1 shows a front view of a prior art pre-filter receptacle without a fish guard;

FIG. 2 shows a side view of a prior art pre-filter receptacle without a fish guard;

FIGS. 3A and 3B respectively show front and side views of an exemplary front fish guard according to the principles of the invention;

FIGS. 4A and 4B respectively show front and side views of an exemplary side fish guard according to the principles of the invention;

FIG. 5 shows a flat panel with aperture for forming a front fish guard according to an exemplary method of manufacture;

FIG. 6 shows a flat panel with aperture for forming a side fish guard according to an exemplary method of manufacture;

FIG. 7 shows a top view of a pre-filter receptacle with an exemplary front fish guard and exemplary side fish guards installed according to the principles of the invention;

FIG. 8 shows a side view of a pre-filter receptacle with an exemplary front fish guard and exemplary side fish guards installed according to the principles of the invention; and

FIG. 9 shows a front view of a pre-filter receptacle with an exemplary front fish guard and exemplary side fish guards installed according to the principles of the invention.

### DETAILED DESCRIPTION

An exemplary fish guard according to the invention is comprised of a panel with a plurality of aperture, and a hook-shaped top section for hanging on a top edge of a pre-filter receptacle. The aperture, which have a diameter approximately equal to the width of the slots, are arranged in columns. Each column of aperture is arranged for alignment with a slot in the pre-filter receptacle. The top of the periphery of the top hole of each column of apertures is approximately adjacent to or slightly below the top of each slot. The bottom of the periphery of the bottom hole of each column of aperture is approximately adjacent to or slightly above the bottom of each slot.

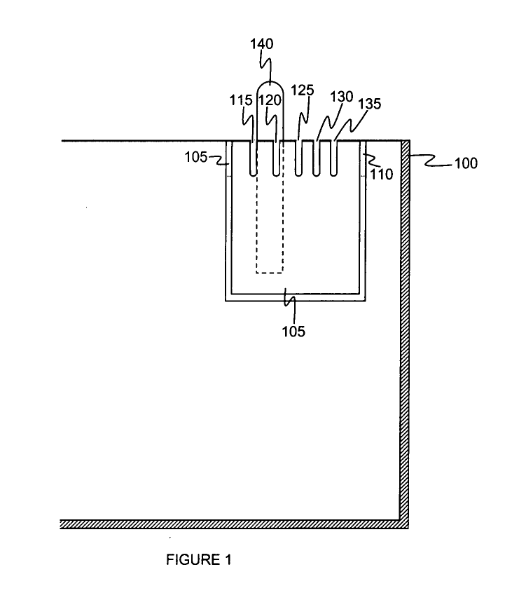

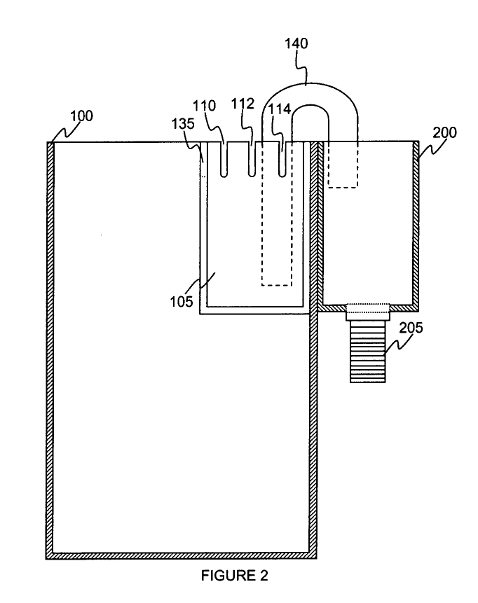

Referring now to FIGS. 1 and 2, front and side views of a prior art pre-filter receptacle 105 on the interior of an aquarium tank 100 and a filter receptacle 200 disposed adjacent to the pre-filter receptacle but on the exterior of the aquarium tank 100, are conceptually illustrated. The pre-filter receptacle 105 includes a generally rectangular shaped bottom wall, a back wall, front wall and side walls. The pre-filter receptacle 105 is typically symmetrical, with the left side being a mirror image of the right side. The top edge portion of each of the side walls and front wall typically has a plurality of vertically disposed slots 110-114 and 115-135. The width of each slot 110-114 and 115-135 is sufficiently large to permit unobstructed passage of foreign matter carried by water from the interior of the aquarium tank to the interior of the pre-filter receptacle. While the slots 110-114 and 115-135 are small enough to typically prevent the passage of large fish, small fish often pass through the pre-filter slots and are drawn into the filter receptacle where they eventually die.

The front and side walls of the pre-filter receptacle 105 typically have different sizes and a different number of slots. By way of example and not limitation, front wall of the pre-filter shown in FIG. 1 includes five (5) slots 115-135. The side walls of the pre-filter shown in FIG. 2 includes three (3) slots 110-114 and 115-135. Such pre-filter configurations are common in the art.

However, the present invention is not limited to a particular shape or configuration of a pre-filter receptacle, or number or arrangement of slots for a pre-filter receptacle. Rather, those skilled in the art will appreciate that the principles of the invention may be readily applied and adapted to various shapes, sizes and configurations of pre-filter receptacles, with various numbers and arrangements of slots. The pre-filter receptacle and corresponding fish guards referenced herein are described for purposes of illustrating exemplary embodiments of the invention.

For illustrative purposes, the filter receptacle 200 includes a bottom wall, a back wall, a front wall, and side walls. One or more partitions may divide the interior of the filter receptacle into a plurality of compartments such as a water-receiving compartment and a water-discharge or drainage compartment. A water-drainage compartment is provided with a drainage opening and conduit 205. The pre-filter receptacle and filter receptacle are typically operatively interconnected by one or more mechanical fasteners, such brackets, clamps and/or bolts.

An inverted U-shaped, tubular siphon tube 140 provides a conduit for fluid communication from the pre-filter 105 to the filter receptacle 200. Water is transferred from the pre-filter receptacle 105 to the filter receptacle 200 by means of the siphoning action afforded by the siphon tube.

An electrically-driven water pump (not shown) receives water from the filter receptacle 200 and discharges the water under pressure to a water return conduit (not shown) extending from the discharge side of the water pump to the aquarium tank 100. One or more filtration devices (not shown) may be disposed between the filter receptacle 200 and water return conduit.

An exemplary fish guard according to the invention is configured to overlay the front and side walls of a conventional pre-filter receptacle 105. Apertures in the fish guard allow the pre-filter to perform without consuming small fish. In an aquarium without small fish, the fish guard may safely be omitted. In an aquarium with small fish, the fish guard may easily be installed.

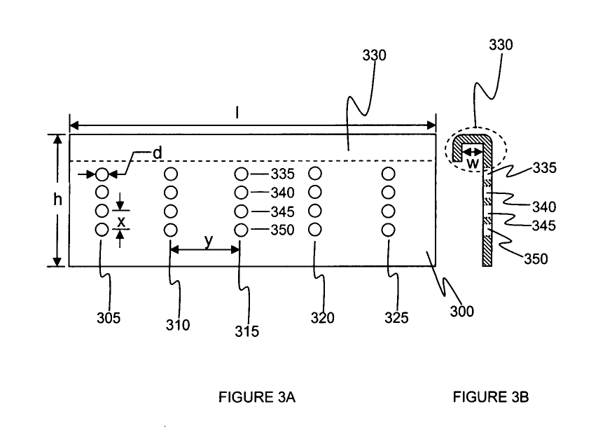

Referring now to FIGS. 3A and 3B, an exemplary fish guard for a front wall of a pre-filter receptacle is shown. Such a fish guard is referred to herein as a front fish guard. The exemplary front fish guard is comprised of a front panel 300, a hook-shaped top section 330 and a plurality of columns 305-325 of vertically aligned apertures 335-350 in the front panel 300. Illustratively, the apertures may be approximately 0.10 to 0.25 inch (e.g., 0.156 inch) diameter (d) circular holes, separated vertically (x) from center to center by approximately 0.15 to 0.35 inches (e.g., 0.219 inches), and separated horizontally (y) from an adjacent column by approximately 0.50 to 1.0 inches (e.g., 0.875 inches). The front panel 330 provides a planar surface that is smaller in height (h) and length (l) than the front wall of the pre-filter receptacle 105. However, the front panel is long (l) and high (h) enough to overlay the slots 115-135 in the front wall of the pre-filter receptacle 105 when the front fish guard is installed. By way of example and not limitation, the height (h) may be approximately 1 to 2 inches (e.g., 1.5 inches) and the length (l) may be approximately 2.5 to 5 inches (e.g., 4.25 inches). Depending upon the configuration of the hooked-shaped top section 330, the back of the hooked-shaped section 330 may have cutouts or aperture in alignment with any overlapped apertures in the front panel 300, without departing from the scope of the invention.

The top hook-shaped section 330 of the fish guard includes an inner periphery and outer periphery. The inner periphery of the hooked shape top section of the exemplary fish guard defines an opening for engaging a top edge of the pre-filter receptacle. In a preferred embodiment the hook-shaped top section 330 defines a generally rectangular opening with a width (w) approximately equal to or slightly greater than the thickness of the edge of the pre-filter receptacle 105 to be engaged by the exemplary fish guard. By way of example and not limitation, the width (w) may be approximately 0.265 inches. The front of the top hook-shaped section 330 extends from the front panel 300. The back downwardly extending portion of the hook-shaped section 330 does not conceal any apertures in the fish guard.

A hook-shaped top section 330 with a width (w) that is substantially larger than the edge of the pre-filter receptacle is considered undesirable. An excessively large width may allow the fish guard to shift. A large width may also allow an appreciable gap to form between the fish guard and the front wall of the pre-filter. The gap may allow eddy currents to form between the aperture in the fish guard and the slots in the pre-filter receptacle. Eddy currents are believed to interfere with flow of debris into the pre-filter receptacle and contribute to algae growth.

The outer periphery of the hooked shaped top section 330 of the exemplary fish guard is preferably substantially parallel to the surfaces of the engaged edge of the pre-filter receptacle. The fish guard, and particularly the top of the hooked shaped top section 330, is preferably relatively thin to avoid interfering with closing a lid of an aquarium. By way of example and not limitation, the fish guard, particularly the hooked shaped top section 330 may be comprised of approximately 0.05 to 0.10 inch (e.g., 0.06 inch) thick material (e.g. Lexan® by General Electric Corporation) to avoid interference.

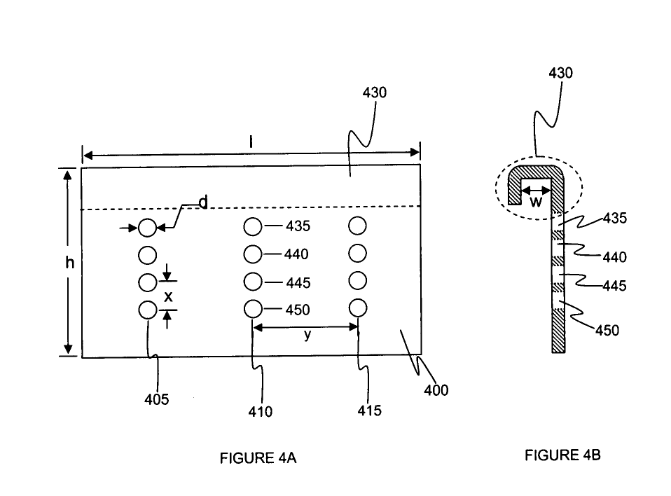

Referring now to FIGS. 4A and 4B, an exemplary fish guard for a side wall of a pre-filter receptacle is shown. Such a fish guard is referred to herein as a side fish guard, and may be applied to either the left or right side of a pre-filter receptacle. The exemplary side fish guard is comprised of a front panel 400, a hook-shaped top section 430 and a plurality of columns 405-415 of vertically aligned apertures 435-450 in the front panel 430. Illustratively, the apertures may be approximately 0.10 to 0.25 inch (e.g., 0.156 inch) diameter (d) circular holes, separated vertically (x) from center to center by approximately 0.15 to 0.35 inches (e.g., 0.219 inches), and separated horizontally (y) from an adjacent column by approximately 0.50 to 1.0 inches (e.g., 0.845 inches). The front panel 430 provides a planar surface that is smaller in height (h) and length (l) than the side wall of the pre-filter receptacle 105. However, the front panel is long (l) and high (h) enough to overlay the slots 110-114 (as shown in FIG. 2) in the side wall of the pre-filter receptacle 105 when the side fish guard is installed. By way of example and not limitation, the height (h) may be approximately 1 to 2 inches (e.g., 1.5 inches) and the length (l) may be approximately 1.5 to 3.5 inches (e.g., 2.75 inches).

The top hook-shaped section 430 of the fish guard includes an inner periphery and outer periphery. The inner periphery of the hooked shape top section of the exemplary fish guard defines an opening for engaging a top edge of the pre-filter receptacle. In a preferred embodiment the hook-shaped top section 430 defines a generally rectangular opening with a width (w) approximately equal to or slightly greater than the thickness of the edge of the pre-filter receptacle 105 (as shown in FIG. 2) to be engaged by the exemplary fish guard. By way of example and not limitation, the width (w) may be approximately 0.265 inches. The front of the top hook-shaped section 430 extends from the front panel 400. The back downwardly extending portion of the hook-shaped section 430 does not conceal any apertures in the fish guard.

A hook-shaped top section 430 with a width (w) that is substantially larger than the edge of the pre-filter receptacle is considered undesirable. An excessively large width may allow the fish guard to shift. A large width may also allow an appreciable gap to form between the fish guard and the front wall of the pre-filter. The gap may allow eddy currents to form between the aperture in the fish guard and the slots in the pre-filter receptacle. Eddy currents are believed to interfere with flow of debris into the pre-filter receptacle and contribute to algae growth.

The outer periphery of the hooked shaped top section 430 of the exemplary fish guard is preferably substantially parallel to the surfaces of the engaged edge of the pre-filter receptacle. The fish guard, and particularly the top of the hooked shaped top section 430, is preferably relatively thin to avoid interfering with closing a lid of an aquarium. By way of example and not limitation, the fish guard, particularly the hooked shaped top section 430 may be comprised of approximately 0.06 inch thick material (e.g. Lexan®) to avoid interference.

In a preferred embodiment, a fish guard according to the invention, is comprised of clear, durable plastic that is easy to clean. By way of example and not limitation, a durable plastic such as a polyacrylate, polycarbonate or the like, e.g. Lexan®, Lucite® (by ICI Acrylics Inc.) and Plexiglass® (by Rohm and Haas Company), may be utilized.

Fish guards according to the invention may be produced using any suitable manufacturing techniques known in the art for the chosen material, such as (for example) injection, compression, structural foam, blow, or transfer molding; polyurethane foam processing techniques; vacuum forming; and casting. Preferably the manufacturing technique is suitable for mass production at relatively low cost per unit, and results in an aesthetically acceptable product with a consistent acceptable quality.

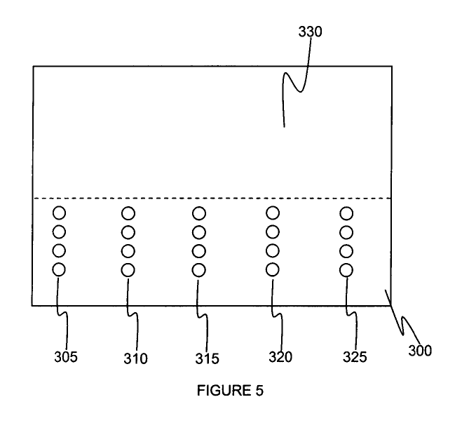

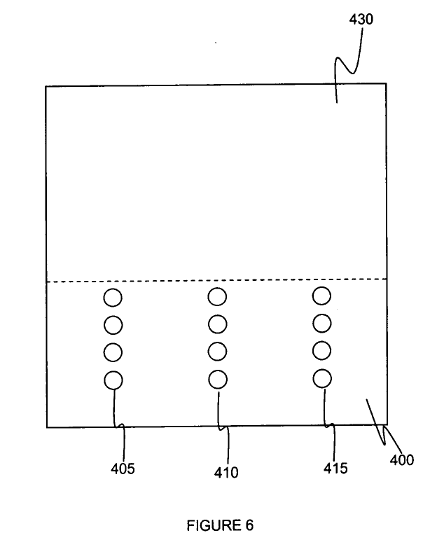

Illustratively, exemplary fish guards may be formed from flat sheets. Referring now to FIGS. 5 and 6, pre-formed flat sheets for forming front and side fish guards according to the invention are conceptually shown. The columns of apertures 305-325 and 405-415 may be formed mechanically (e.g., by drilling) or by any other method for efficiently forming a plurality of apertures of determined shape, size and location in the selected material. The hooked-shape top sections 330 and 430 may be formed by heating and bending to a determined shape.

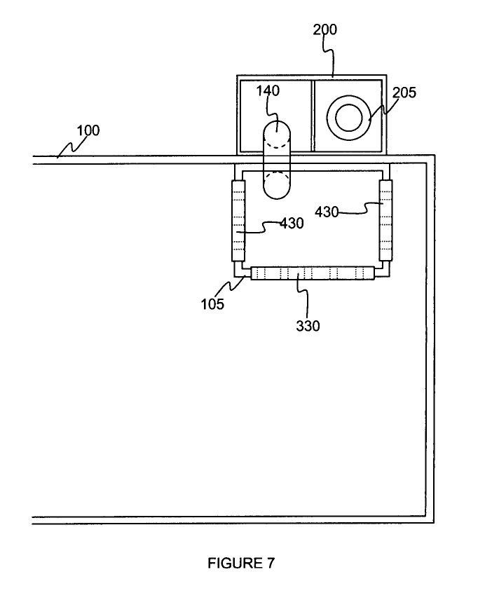

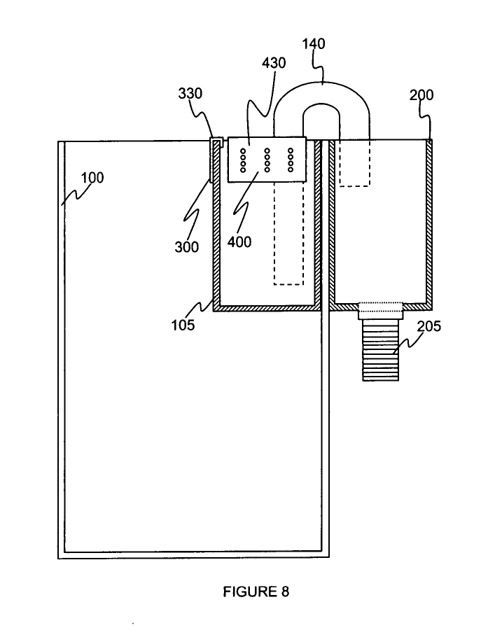

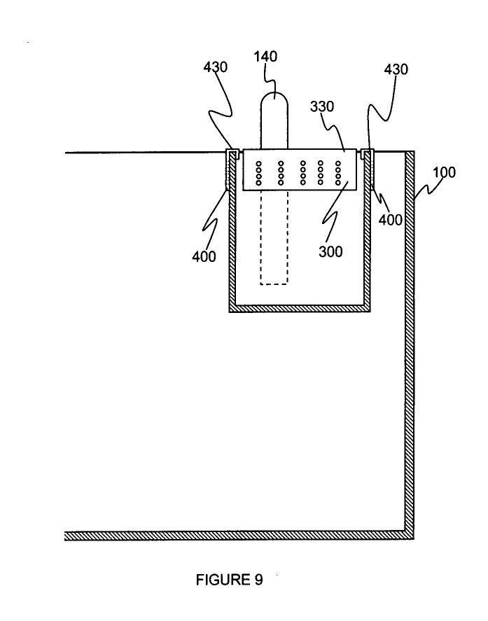

Installing the exemplary fish guards entails placing the top hook-shaped sections 330 and 430 of the front fish guard and a pair of side fish guards over top edges of the front and side walls of a pre-filter receptacle 105, respectively, as shown in the top, side and front and side views of FIGS. 7 through 9. The front and side fish guards are oriented so that the front panels 300 and 400 are against the exterior side of the front and side walls of the pre-filter receptacle 105. The fish guards may be easily removed for cleaning and/or replacement as necessary or desired.

Those skilled in the art will appreciate that the invention may be embodied in a kit. A fish guard kit may include a front fish guard and two side fish guards, in conformance with the principles of the invention as described above for particular exemplary front and side fish guards.

The embodiment of the invention chosen for the purposes of description and illustration herein, is an exemplary embodiment for achieving objects of the invention and developing the utility thereof in the most desirable manner, due regard being had to existing factors of economy, simplicity of design and construction, manufacturing techniques and the improvements sought to be effected. It will be appreciated, therefore, that the particular structural and functional aspects emphasized herein are not intended to exclude, but rather to suggest, such other adaptations and modifications of the invention, as fall within the spirit and scope of the invention as defined in the appended claims. While the invention has been described in terms of various embodiments and implementations, those skilled in the art will recognize that the invention can be practiced with modification within the spirit and scope of the appended claims.

We claim the following:

1. A fish guard for an aquarium receptacle having a plurality of vertically disposed slots, a front wall, a left side wall and a right side wall, each of said walls having a top edge, said fish guard comprising:
a panel;
a plurality of columns of apertures, each column of apertures including a plurality of apertures disposed in substantial horizontal alignment;
a hooked shape top section operatively attached to said panel and configured to engage a top edge of a wall of the aquarium receptacle;
each of said plurality of columns of apertures being substantially in vertical alignment and horizontal alignment with one of said plurality of vertically disposed slots when said fish guard is installed on the aquarium receptacle.

2. The fish guard of claim 1 being configured to detachably attach to the front wall of the aquarium receptacle.

3. The fish guard of claim 2 wherein the plurality of apertures are comprised of approximately 0.10 to 0.25 inch diameter circular holes.

4. The fish guard of claim 2 wherein each aperture in a column of apertures is separated vertically from an adjacent aperture, measured aperture center to adjacent aperture center, by approximately 0.15 to 0.35 inches.

5. The fish guard of claim 2 wherein each column of apertures is separated horizontally from an adjacent column of apertures by approximately 0.50 to 1.0 inches.

6. The fish guard of claim 2 wherein the panel is approximately 1 to 2 inches in height and approximately 2.5 to 5 inches in length.

7. The fish guard of claim 1 being configured to detachably attach to a side wall of the aquarium receptacle.

8. The fish guard of claim 7 wherein the plurality of apertures are comprised of approximately 0.10 to 0.25 inch diameter circular holes.

9. The fish guard of claim 7 wherein each aperture in a column of apertures is separated vertically from an adjacent aperture, measured aperture center to adjacent aperture center, by approximately 0.15 to 0.35 inches.

10. The fish guard of claim 7 wherein each column of apertures is separated horizontally from an adjacent column of apertures by approximately 0.50 to 1.0 inches.

11. The fish guard of claim 2 wherein the panel is approximately 1 to 2 inches in height and approximately 1.5 to 3.5 inches in length.

12. The fish guard of claim 1, wherein the top edge of the wall of the aquarium receptacle has a wall thickness and the hooked shape top section of the fish guard defines an opening approximately equal to the wall thickness.

13. The fish guard of claim 1, wherein the hooked shape top section has a thickness, said thickness being approximately 0.05 to 0.10 inches.

14. A fish guard kit for an aquarium receptacle having a plurality of vertically disposed slots, a front wall, a left side wall and a right side wall, each of said walls having a top edge, said kit including a front fish guard and two side fish guards, each fish guard comprising:
a panel;
a plurality of columns of apertures, each column of apertures including a plurality of apertures disposed in substantial horizontal alignment;
a hooked shape top section operatively attached to said panel and configured to engage a top edge of a wall of the aquarium receptacle;
each of said plurality of columns of apertures being substantially in vertical alignment and horizontal alignment with one of said plurality of vertically disposed slots when said fish guard is installed on the aquarium receptacle.

15. The fish guard kit of claim 14, each fish guard being configured to detachably attach to a wall of the aquarium receptacle.

16. The fish guard kit of claim 14 wherein the plurality of apertures are comprised of approximately 0.10 to 0.25 inch diameter circular holes.

17. The fish guard of claim 1, wherein the top edge of each wall of the aquarium receptacle has a wall thickness and the hooked shape top section of each fish guard defines an opening approximately equal to the wall thickness.
